(19) United States
(12) Patent Application Publication
(10) Pub. No.: US 2025/0245990 A1
(43) Pub. Date: Jul. 31, 2025

(54) COLLECTIVE ABNORMAL BEHAVIOR ANALYSIS METHOD AND DEVICE BASED ON DYNAMIC TOPOLOGY

(71) Applicant: NETTALENT TECHNOLOGY (GUANGZHOU) GROUP CO., LTD., Guangzhou (CN)

(72) Inventors: Sheng GAO, Guangzhou (CN); He MA, Guangzhou (CN); Shujuan DONG, Guangzhou (CN); Xiaoming NI, Guangzhou (CN); Nanming GUO, Guangzhou (CN); Le WANG, Guangzhou (CN)

(21) Appl. No.: 19/022,135

(22) Filed: Jan. 15, 2025

Related U.S. Application Data
(63) Continuation of application No. PCT/CN2024/131916, filed on Nov. 14, 2024.

(30) Foreign Application Priority Data
Jan. 29, 2024 (CN) 2024101190596

(51) Int. Cl. G06V 20/52; G06T 5/20; G06T 5/70; G06T 7/70; G06V 20/70; G06V 40/16; G06V 40/20

(52) U.S. Cl. CPC G06V 20/52; G06T 5/20; G06T 5/70; G06T 7/70; G06V 20/70; G06V 40/172; G06V 40/20; G06T 2207/20044

(57) ABSTRACT

Disclosed are a collective abnormal behavior analysis method and device based on dynamic topology, including acquiring examination monitoring video data of an examination room; selecting key frames from examination frame data, performing face recognition on the key frames in sequence, and labeling the examinee information on the key frames; constructing skeletal topology for each examinee, and continuously monitoring the skeletal topology and the examination monitoring video data; recording suspicious postures of each skeletal topology in sequence, and obtaining an actual spacing distance between skeletal topologies of each of the suspicious postures based on coordinate information of the skeletal topology with suspicious posture in the examination monitoring video data; taking the skeletal topologies of two suspicious postures corresponding to the actual spacing distance as abnormal behavior skeletons, and outputting the examinee information labeled in the abnormal behavior skeletons to complete the analysis of collective abnormal behavior.

### CROSS-REFERENCE TO RELATED APPLICATIONS

The present application claims priority to Chinese Patent Application No. 2024101190596, filed on Jan. 29, 2024, the entire disclosure of which is incorporated herein by reference.

### TECHNICAL FIELD

The present disclosure relates to the technical field of behavior recognition, and particularly relates to a collective abnormal behavior analysis method and device based on dynamic topology.

### BACKGROUND

With the development of visual recognition technology, machine vision recognition technology used in an examination room can accurately acquire behavior and actions of an individual examinee, and the acquired images can be then processed to determine whether the behavior and actions of the examinee in the examination room during an examination is suspicious of any abnormal actions.

At present, abnormal behavior is primarily detected and recognized through machine vision recognition, so as to monitor the abnormal behavior of the examinee. However, image recognition relies solely on image to recognize behavior of the examinee, which could result in significant blind spots for visual recognition. For example, when an examinee places his/her hand under a desk, movements of the hand cannot be predicted or recognized through the image recognition, resulting in the inability to detect specific actions under this situation. In addition, existing abnormal behavior detection only focuses on the individual examine, and is incapable of accurately recognizing collective abnormal behavior among examinees, such that the examinees involved in the collective abnormal behavior can exchange answers through collective actions, making the existing abnormal action recognition system unable to be accurately analyze, and effectively recognize the collective abnormal behavior.

Therefore, there is an urgent need for a method capable of detecting and analyzing collective abnormal behavior among examinees, thereby improving the accuracy and efficiency of the detection and analysis of the collective abnormal behavior.

### SUMMARY

The present disclosure provides a collective abnormal behavior analysis method and device based on dynamic topology to solve the technical problem in the prior art that it is impossible to accurately and efficiently detect and analyze the collective abnormal behavior among examinees.

In order to solve the above technical problems, the embodiment of the present disclosure provides a collective abnormal behavior analysis method based on dynamic topology, including:
acquiring examination monitoring video data of an examination room, and performing frame division and preprocessing on the video data to obtain examination frame data, where the video data after frame division includes a plurality of examination frame data;
selecting key frames from the examination frame data, performing face recognition on the key frames in sequence, comparing recognized faces with a preset examinee information database for analysis, and labeling examinee information obtained through analysis in the key frames;
capturing skeletal topology information of labeled faces, constructing skeletal topology for each examinee, and continuously monitoring the skeletal topology and the examination monitoring video data according to a preset suspicious behavior recognition model;
recording suspicious postures of each skeletal topology in sequence, and obtaining an actual spacing distance between skeletal topologies of each of the suspicious postures based on coordinate information of the skeletal topology with suspicious posture in the examination monitoring video data; and
when the actual spacing distance is less than a preset value, skeletal topologies of two suspicious postures corresponding to the actual spacing distance are taken as abnormal behavior skeletons, and the examinee information labeled in the abnormal behavior skeletons are outputted to complete the analysis of collective abnormal behavior.

As a preferred solution, the acquiring examination monitoring video data of an examination room, and performing frame division and preprocessing on the video data are specifically as follows:
acquiring the examination monitoring video data of the examination room via a camera;
performing frame division of the examination monitoring video data to obtain image frames; and
performing Gaussian filtering, image denoising, and image enhancement processing on the image frames to obtain the examination frame data.

As a preferred solution, the selecting key frames from the examination frame data, performing face recognition on the key frames in sequence, comparing recognized faces with a preset examinee information database for analysis, and labeling examinee information obtained through analysis in the key frames are specifically as follows:
performing the face recognition on all the examination frame data using a face recognition model, selecting the key frames from the examination frame data where faces are not occluded accordingly, and obtaining face information after the face recognition of the key frames, where all faces can be recognized in each of the key frames; and
the recognized face information is compared with the preset examinee information database, and the examinee information is labeled to the recognized face information in each of the key frames.

As a preferred solution, the capturing skeletal topology information of labeled faces, constructing skeletal topology for each examinee, and continuously monitoring the skeletal topology and the examination monitoring video data based on a preset suspicious behavior recognition model are specifically as follows:
capturing skeletal topology information of the faces with the examinee information labeled on all the key frames, and constructing the skeletal topology for each examinee in sequence;
performing behavior posture recognition on the skeletal topology for each examinee according to the preset behavior recognition model to obtain behavior information of each examinee in each of the key frames;
predicting and supplementing skeletal posture and behavior information of each examinee at a corresponding moment on a non-key frame according to the behavior information of each examinee in each of the key frames, so as to obtain complete behavior information of each examinee in the examination monitoring video data; and
monitoring and recognizing the complete behavior information of each examinee in the examination monitoring video data using the preset suspicious behavior recognition model to obtain skeletal topology with suspicious behavior, where the suspicious behavior includes all actions unrelated to writing, reading, and head-up actions.

As a preferred solution, the predicting and supplementing skeletal posture and behavior information of each examinee at a corresponding moment on a non-key frame according to the behavior information of each examinee in each of the key frames, so as to obtain complete behavior information of each examinee in the examination monitoring video data are specifically as follows:
predicting and supplementing the complete behavior information of each examinee in sequence, such that examination frame images are extracted according to the preset behavior recognition model in the process, complete skeletal topology and behavior information of the examinee in the examination video data can be recognized through the examination frame images, skeletal posture and behavior in sequence are predicted according to the behavior predict model for a frame moment corresponding to the examination frame data from which the skeletal topology and behavior information of the examinee cannot be recognized in combination with the behavior information of each key frame of the examinee, skeletal posture and behavior information predicted therefrom are then inputted in sequence into the examination frame data at the frame moment until the examination frame data of all frame moments have the skeletal posture and behavior information of the examinee, such that the complete behavior information of the examinee is acquired; and
until complete behavior information of all examinees in the examination monitoring video data is acquired.

As a preferred solution, the step of when the actual spacing distance is less than a preset value, the skeletal topologies of the two suspicious postures corresponding to the actual spacing distance are taken as abnormal behavior skeletons, and the examinee information labeled in the abnormal behavior skeletons are outputted to complete the analysis of collective abnormal behavior are specifically as follows:
when the actual spacing distance is less than the preset value, the skeletal topologies of the two suspicious postures corresponding to the actual spacing distance are taken as abnormal behavior analysis skeletons;
behavior recognition is performed on the abnormal behavior analysis skeletons in sequence; when suspicious behavior is recognized in one of the abnormal behavior analysis skeletons, behavior information of all accomplice skeletons with a preset distance of the abnormal behavior analysis skeleton is obtained, such that whenever the abnormal behavior analysis skeleton performs the suspicious behavior, a number of times that the abnormal behavior analysis skeletons and the accomplice skeletons thereof cyclically perform a same action is recorded when any of the accomplice skeletons is recognized performing head-up action and/or writing action; and
when the number of times exceeds a preset number of times, the abnormal behavior analysis skeleton and the accomplice skeletons are taken as the abnormal behavior skeletons, and the examinee information labeled in the abnormal behavior skeletons is outputted.

As a preferred solution, the above step further includes:
when the actual spacing distance is great than or equal to the preset value, behavior recognition is performed on the skeletal topologies of suspicious postures is recognized;
whenever suspicious behavior is recognized in one of the skeletal topologies of suspicious postures, behavior information of all accomplice skeletons with a preset distance of the skeletal topology is obtained, such that whenever the one of the skeletal topologies of suspicious postures perform the suspicious behavior, a number of times that the one of the skeletal topologies of suspicious postures and the accomplice skeletons thereof cyclically perform a same action is recorded when any of the accomplice skeletons is recognized performing head-up action and/or writing action; and
when the number of times exceeds the preset number of times, the one of the skeletal topologies of suspicious postures and the accomplice skeletons thereof are taken as the abnormal behavior skeletons, and the examinee information labeled in the abnormal behavior skeletons is outputted.

Accordingly, the present disclosure further provides a collective abnormal behavior analysis device based on dynamic topology, including an acquisition module, a recognition module, a skeleton module, a distance module and an analysis module;
the acquisition module is configured for acquiring examination monitoring video data of an examination room, and performing frame division and preprocessing on the video data to obtain examination frame data, where the video data after frame division includes a plurality of examination frame data;
the recognition module is configured for selecting key frames from the examination frame data, performing face recognition on the key frames in sequence, comparing recognized faces with a preset examinee information database for analysis, and labeling examinee information obtained through analysis in the key frames.
the skeleton module is configured for capturing skeletal topology information of labeled faces, constructing skeletal topology for each examinee, and continuously monitoring the skeletal topology and the examination monitoring video data based on a preset suspicious behavior recognition model;
the distance module is configured for recording suspicious postures of each skeletal topology in sequence, and obtaining an actual spacing distance between skeletal topologies of each of the suspicious postures based on coordinate information of the skeletal topology with suspicious posture in the examination monitoring video data; and
the analysis module is configured for outputting the examinee information labeled in the abnormal behavior skeletons to complete the analysis of collective abnormal behavior when the actual spacing distance is less than a preset value, the skeletal topologies of the two suspicious postures corresponding to the actual spacing distance are taken as abnormal behavior skeletons.

Accordingly, the present disclosure further provides a terminal device, including a processor, a memory, and a computer program stored in the memory and configured to be executed by the processor. When the processor executes the computer program, the collective abnormal behavior analysis method based on dynamic topology as described in any of the embodiments above can be implemented.

Accordingly, the present disclosure further provides a computer-readable storage medium, where the computer-readable storage medium includes a stored computer program, and when the computer program runs, the device on which the computer-readable storage medium is located is controlled to execute the collective abnormal behavior analysis method based on dynamic topology as described in any of the embodiments above.

Compared with the prior art, the embodiment of the present disclosure has the following beneficial effects:

The technical solution of the present disclosure acquires the examination monitoring video data from the examination room. After performing frame division and preprocessing, key frames are selected, and the examinee information corresponding to the recognized face in sequence is labeled, skeletal topology information of the labeled face is captured to construct skeletal topology for each examinee, the skeletal topology and the examination monitoring video data are continuously monitored according to a preset suspicious behavior recognition model; the skeletal topologies of the two suspicious postures corresponding to the actual spacing distance are accurately and quickly determined in combination with the an actual spacing distance between skeletal topologies of each of the suspicious postures, such that the information of corresponding examinees involved in the collective abnormal behavior is quickly outputted; and the analysis of skeletal behavior can avoid blind spots of machine vision recognition, and address inaccuracies in machine vision behavior detection, thereby improving the accuracy of collective abnormal behavior detection by combining the detection of actual spacing distance.

### BRIEF DESCRIPTION OF THE DRAWINGS

FIG. 1 is a flowchart of steps of a collective abnormal behavior analysis method based on dynamic topology according to an embodiment of the present disclosure.

FIG. 2 is a structural schematic diagram of a collective abnormal behavior analysis device based on dynamic topology according to an embodiment of the present disclosure.

### DETAILED DESCRIPTIONS OF THE EMBODIMENTS

The technical solutions of embodiments of the present disclosure will be described below clearly and comprehensively in conjunction with accompanying drawings of the embodiments of the present disclosure. Apparently, the embodiments described are merely some embodiments rather than all embodiments of the present disclosure. On the basis of the embodiments in the present disclosure, all other embodiments acquired by those of ordinary skill in the art without making creative efforts fall within the scope of protection of the present disclosure.

### Embodiment

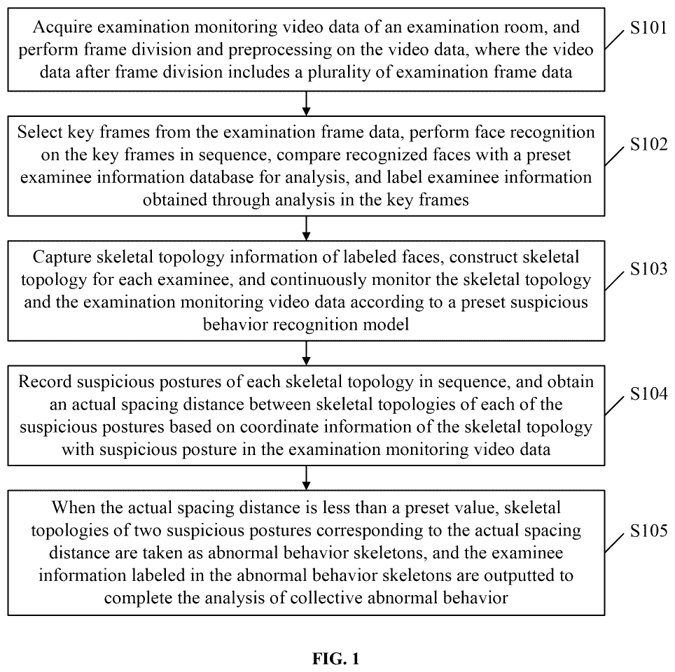

With reference to FIG. 1, this embodiment provides a collective abnormal behavior analysis method based on dynamic topology, including the following steps S101-S105:

step S101: acquiring examination monitoring video data of an examination room, and performing frame division and preprocessing on the video data to obtain examination frame data, where the video data after frame division includes a plurality of examination frame data.

As a preferred solution of this embodiment, the acquiring examination monitoring video data of an examination room, and performing frame division and preprocessing on the video data are specifically as follows:
acquiring the examination monitoring video data of the examination room via a camera; performing frame division of the examination monitoring video data to obtain image frames; and performing Gaussian filtering, image denoising, and image enhancement processing on the image frames to obtain the examination frame data.

In this embodiment, by using a camera, the examination monitoring video data from of the examination room can be acquired via the camera, such that the acquired video data can be subject to frame division, and a volume of the overall video data can be reduced. It can be understood that since an examination usually lasts more than half an hour but less than four hours, processing all the video data could be of great complexity, massive data, and low data processing efficiency. Therefore, a number of frames per second can be reduced by performing frame division of the video data, thereby achieving an overall data quantity of the video data. Preferably, the video data can be divided into a frame rate of one frame per second, which can significantly reduce the data processing workload compared to the usual 30 or 60 frames per second.

Further, Gaussian filtering, image denoising, and image enhancement processing are performed on each of the image frames of the video data after frame division, such that the examination frame data capable of being processed quickly, efficiently, and accurately can be obtained.

Step S102: selecting key frames from the examination frame data, performing face recognition on the key frames in sequence, comparing recognized faces with a preset examinee information database for analysis, and labeling examinee information obtained through analysis in the key frames.

As a preferred solution of this embodiment, the selecting key frames from the examination frame data, performing face recognition on the key frames in sequence, comparing recognized faces with a preset examinee information database for analysis, and labeling examinee information obtained through analysis in the key frames are specifically as follows:
performing the face recognition on all the examination frame data using a face recognition model, selecting the key frames from the examination frame data where faces are not occluded accordingly, and obtaining face information after the face recognition of the key frames, where all faces can be recognized in each of the key frames; and the recognized face information is compared with the preset examinee information database, and the examinee information is labeled to the recognized face information in each of the key frames.

In this embodiment, accurate face recognition can be performed on all the examination frame data via the face recognition model, frames where the faces are not occluded are selected from the examination frame data as the key frames, and the face information after face recognition of the key frames is recognized, such that the examinee information corresponding to the face information can be obtained in the preset examinee information database. Preferably, the face information can be results of face recognition, a face on the key frame can be determined to correspond to the examinee information in the preset examinee information database by comparing the results of face recognition with images in the preset examinee information database.

It should be noted that the face recognition model can be a facial recognition model, which, after being trained, can accurately recognize facial feature information in the image.

It can be understood that the selecting key frames where faces are not occluded can improve the accuracy of face recognition, avoiding the low accuracy of face recognition and subsequent skeletal feature extraction due to occlusion, thereby resulting in low accuracy of abnormal behavior analysis.

Step S103: capturing skeletal topology information of labeled faces, constructing skeletal topology for each examinee, and continuously monitoring the skeletal topology and the examination monitoring video data according to a preset suspicious behavior recognition model.

As a preferred solution of this embodiment, the capturing skeletal topology information of labeled faces, constructing skeletal topology for each examinee, and continuously monitoring the skeletal topology and the examination monitoring video data based on a preset suspicious behavior recognition model are specifically as follows:
capturing skeletal topology information of the faces with the examinee information labeled on all the key frames, and constructing the skeletal topology for each examinee in sequence; performing behavior posture recognition on the skeletal topology for each examinee according to a preset behavior recognition model to obtain the behavior information of each examinee in each of the key frames; predicting and supplementing skeletal posture and behavior information of each examinee at a corresponding moment on a non-key frame according to the behavior information of each examinee in each of the key frames, so as to obtain complete behavior information of each examinee in the examination monitoring video data; and monitoring and recognizing the complete behavior information of each examinee in the examination monitoring video data using the preset suspicious behavior recognition model to obtain skeletal topology with suspicious behavior, where the suspicious behavior includes all actions unrelated to writing, reading, and head-up actions.

In this embodiment, the skeletal feature information corresponding to each examinee is obtained by capturing skeletal topology information of the faces with the examinee information labeled on all the key frames, such that the skeletal topology for each examinee can be accurately constructed according to the skeletal feature information, current behavior posture corresponding to the skeletal topology of each examinee can be recognized according to the preset behavior recognition model, and a current behavioral state corresponding to the skeletal topology of each examinee can also be recognized. Specifically, the behavior recognition model is obtained through pre-training, and the behavior recognition model can be trained by inputting various skeletal posture data observed during an examination process.

In this embodiment, only all key frame data is captured. Since the behavior information corresponding to each of the key frames is obtained, it is necessary to predict and supplement skeletal posture and behavior information of each examinee at a corresponding moment on a non-key frame, to ensure that behavior of each examinee is monitored throughout the entire examination.

In this embodiment, the complete behavior information of each examinee in the examination monitoring video data is monitored and recognized by using the preset suspicious behavior recognition model, so as to obtain skeletal topology with suspicious behavior. Specifically, the suspicious behavior can include all actions that are unrelated to writing, reading, or head-up actions, such as looking around, looking up for an extended period of time, movements or positions of hands in a non-writing state, and shaking legs. It can be understood that the recognition of suspicious behavior can be achieved through the behavior recognition model. Actions that are not labeled as normal examination actions can be considered as suspicious behavior by recording normal examination behavior of normal examinees and labeling normal examination actions of the normal examinees during the examination. The behavior recognition model used for suspicious behavior recognition can also be trained by inputting normal examination behavior, such as writing, reading, and head-up actions in advance, as training data, so as to obtain the behavior recognition model capable of recognizing normal examination behavior, and then using a condition that an action not labeled as normal examination action of the normal examinee during the examination as output of the model, and finally a suspicious behavior recognition model is obtained through training.

As a preferred solution of this embodiment, the predicting and supplementing skeletal posture and behavior information of each examinee at a corresponding moment on a non-key frame according to the behavior information of each examinee in each of the key frames, so as to obtain complete behavior information of each examinee in the examination monitoring video data are specifically as follows:
predicting and supplementing the complete behavior information of each examinee in sequence, such that examination frame images are extracted according to the preset behavior recognition model in the process, the examination frame images are capable of recognizing complete skeletal topology and behavior information of the examinee in the examination monitoring video data, skeletal posture and behavior in sequence are predicted according to the behavior predict model for a frame moment corresponding to the examination frame data from which the skeletal topology and behavior information of the examinee cannot be recognized in combination with the behavior information of each key frame of the examinee, skeletal posture and behavior information predicted therefrom are then inputted in sequence into the examination frame data at the frame moment until the examination frame data of all frame moments have the skeletal posture and behavior information of the examinee, such that the complete behavior information of the examinee is acquired; and until complete behavior information of all examinees in the examination monitoring video data is acquired.

In this embodiment, the examination frame images capable of recognizing complete skeletal topology and behavior information of the examinee in the examination monitoring video data can be recognized through the preset behavior recognition model, such that the corresponding examination frame images can be extracted, skeleton information and behavior information of two frames before and after a missing frame moment can be recognized according to the behavior predict model in combination with the behavior information of each key frame of the examinee, and the information corresponding to the missing frame moment can be predicted, such that skeleton information and behavior information of the examinee in all data frames of the examination monitoring video data can be supplemented and obtained.

Further, a difference of moments between the two frames corresponding to the missing frame moment is too great, there may be a situation that the examinee deliberately avoids the camera, indicating a possible suspicion of abnormal behavior, in which case, information of the examinee will be directly outputted.

It can be understood that the supplementing skeleton information and behavior information of the examinee in all data frames can ensure accurate monitoring of actions and accurate analysis of abnormal behavior of the examination through the examination.

Step S104: recording suspicious postures of each skeletal topology in sequence, and obtaining an actual spacing distance between skeletal topologies of each of the suspicious postures based on coordinate information of the skeletal topology with suspicious posture in the examination monitoring video data.

In this embodiment, skeletal topologies with suspicious postures can be labeled by recording suspicious postures of each skeletal topology in sequence, such that the coordinate information of the labeled skeletal topology with suspicious posture in the examination monitoring video data can be obtained, and the actual spacing distance between skeletal topologies of each of the suspicious postures can be determined according to position and zoom ratio of each camera.

It can be understood that since the examinee is not allowed to move around freely after the examination starts, a desk position can also be obtained. By inputting seat number information of the examinee in advance, an examinee skeleton can be matched to seat information, allowing for a more accurate determination of the actual spacing distance between each seat, that is, the actual spacing distance between each skeletal topology.

Step S105: when the actual spacing distance is less than a preset value, the skeletal topologies of the two suspicious postures corresponding to the actual spacing distance are taken as abnormal behavior skeletons, and the examinee information labeled in the abnormal behavior skeletons are outputted to complete the analysis of collective abnormal behavior.

As a preferred solution of this embodiment, the step of when the actual spacing distance is less than a preset value, the skeletal topologies of the two suspicious postures corresponding to the actual spacing distance are taken as abnormal behavior skeletons, and the examinee information labeled in the abnormal behavior skeletons are outputted to complete the analysis of collective abnormal behavior are specifically as follows:
when the actual spacing distance is less than the preset value, the skeletal topologies of the two suspicious postures corresponding to the actual spacing distance are taken as abnormal behavior analysis skeletons; behavior recognition is performed on the abnormal behavior analysis skeletons in sequence; when suspicious behavior is recognized in one of the abnormal behavior analysis skeletons, behavior information of all accomplice skeletons with a preset distance of the abnormal behavior analysis skeleton is obtained, such that whenever the abnormal behavior analysis skeleton performs the suspicious behavior, a number of times that the abnormal behavior analysis skeletons and the accomplice skeletons thereof cyclically perform a same action is recorded when any of the accomplice skeletons is recognized performing head-up action and/or writing action; and when the number of times exceeds a preset number of times, the abnormal behavior analysis skeleton and the accomplice skeletons are taken as the abnormal behavior skeletons, and the examinee information labeled in the abnormal behavior skeletons is outputted.

In this embodiment, when the skeletal topologies of the two suspicious postures are recognized for which the actual spacing distance is less than the preset value, indicating that two examinees may have abnormal behavior, exemplarily, the two examinees are designated as Examinee A and Examinee B, respectively. Preferably, the preset value can be set according to actual situation of the examination room and seat conditions. The skeletal topologies of the two suspicious postures corresponding to the actual spacing distance are taken as abnormal behavior analysis skeletons, the behavior information of all accomplice skeletons within the preset distance of the abnormal behavior analysis skeleton is obtained when suspicious behavior is recognized in one of the abnormal behavior analysis skeletons (Examinee A or Examinee B), exemplarily, the abnormal behavior analysis skeleton is Examinee A, and all the accomplice skeletons thereof include Examinee a, Examinee b, Examinee b, Examinee d, Examinee e and Examinee f. Whenever Examinee A performs suspicious behavior, including but not limited to: resting his/her chin on his/her left or right hand, pushing up his/her glasses, or crossing his/her legs (the examinees could have agreed on an answer-sharing scheme, that is, which action corresponds to which answer. For example, one action can be matched to one option for multiple-choice questions, so as to transmit the answer by making the corresponding action). When one or more of Examinees a, b, c, d, e, or f is observed performing head-up or writing actions, indicating a collective abnormal behavior where Examine A is transmitting answers to Examinees a, b, c, d, e, or f who is performing head-up or writing actions. However, in order to avoid an incidental event, continuous monitoring will be given on the collective abnormal behavior by recording the number of times that the abnormal behavior analysis skeletons and the accomplice skeletons thereof cyclically perform the same action, that is, the number of times of the collective abnormal behavior. When the number of times is greater than the preset number of times, it is sufficient to indicate the existence of collective abnormal behavior, the abnormal behavior analysis skeletons and the accomplice skeletons thereof are taken as the abnormal behavior skeletons, and the examinee information labeled in the abnormal behavior skeletons is outputted.

As a preferred solution of this embodiment, the above step further includes:
when the actual spacing distance is great than or equal to the preset value, behavior recognition is performed on the skeletal topologies of suspicious postures is recognized; whenever suspicious behavior is recognized in one of the skeletal topologies of suspicious postures, behavior information of all accomplice skeletons with a preset distance of the skeletal topology is obtained, such that whenever the one of the skeletal topologies of suspicious postures perform the suspicious behavior, a number of times that the one of the skeletal topologies of suspicious postures and the accomplice skeletons thereof cyclically perform a same action is recorded when any of the accomplice skeletons is recognized performing head-up action and/or writing action; and when the number of times exceeds the preset number of times, the one of the skeletal topologies of suspicious postures and the accomplice skeletons thereof are taken as the abnormal behavior skeletons, and the examinee information labeled in the abnormal behavior skeletons is outputted.

It can be understood that examinees attempting to participate in collective abnormal behavior may be seated far part but they can still be able to see actions of the others. Therefore, the skeletal topologies of suspicious postures with a great actual spacing distance, it is necessary to recognize and record the execution of suspicious behavior and accomplice skeletons, such that the examinees involved in the collective abnormal behavior can be accurately and quickly recognized.

It can be understood that the embodiments of the present disclosure primarily focus on behavior recognition of the collective abnormal behavior, particularly the collective abnormal behavior for which pre-agreed action are executed during the examination to transmit the answers. However, existing abnormal behavior recognition systems are unable to effectively recognize abnormal behavior in a scenario of the collective abnormal behavior, such that the recognition of action of an individual examinee cannot accurately reflect the behavior of all examinees in the examination room. In the present disclosure, focus can be placed on the behavior of all examinees in the examination room, the collective abnormal behavior can be avoided through skeleton-based behavior recognition, improving accuracy and efficiency of abnormal behavior detection.

The above embodiment has the following effects:

The technical solution of the present disclosure acquires the examination monitoring video data from the examination room. After performing frame division and preprocessing, key frames are selected, and the examinee information corresponding to the recognized face in sequence is labeled, skeletal topology information of the labeled face is captured to construct skeletal topology for each examinee, the skeletal topology and the examination monitoring video data are continuously monitored according to a preset suspicious behavior recognition model; the skeletal topologies of the two suspicious postures corresponding to the actual spacing distance are accurately and quickly determined in combination with the an actual spacing distance between skeletal topologies of each of the suspicious postures, such that the information of corresponding examinees involved in the collective abnormal behavior is quickly outputted; and the analysis of skeletal behavior can avoid blind spots of machine vision recognition, and address inaccuracies in machine vision behavior detection, thereby improving the accuracy of collective abnormal behavior detection by combining the detection of actual spacing distance.

### Embodiment

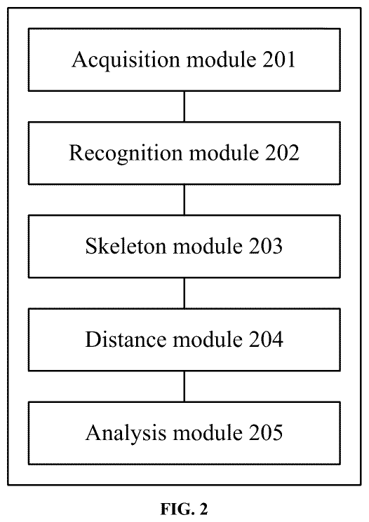

With reference to FIG. 2, the present disclosure further provides a collective abnormal behavior analysis device based on dynamic topology, including an acquisition module 201, a recognition module 202, a skeleton module 203, a distance module 204 and an analysis module 205.

Specifically, the acquisition module 201 is configured for acquiring examination monitoring video data of an examination room, and performing frame division and preprocessing on the video data to obtain examination frame data, where the video data after frame division includes a plurality of examination frame data;
the recognition module 202 is configured for selecting key frames from the examination frame data, performing face recognition on the key frames in sequence, comparing recognized faces with a preset examinee information database for analysis, and labeling examinee information obtained through analysis in the key frames.
the skeleton module 203 is configured for capturing skeletal topology information of labeled faces, constructing skeletal topology for each examinee, and continuously monitoring the skeletal topology and the examination monitoring video data based on a preset suspicious behavior recognition model;
the distance module 204 is configured for recording suspicious postures of each skeletal topology in sequence, and obtaining an actual spacing distance between skeletal topologies of each of the suspicious postures based on coordinate information of the skeletal topology with suspicious posture in the examination monitoring video data; and
the analysis module 205 is configured for outputting the examinee information labeled in the abnormal behavior skeletons to complete the analysis of collective abnormal behavior when the actual spacing distance is less than a preset value, the skeletal topologies of the two suspicious postures corresponding to the actual spacing distance are taken as abnormal behavior skeletons.

As a preferred solution, the acquiring examination monitoring video data of an examination room, and performing frame division and preprocessing on the video data are specifically as follows:
acquiring the examination monitoring video data of the examination room via a camera;
performing frame division of the examination monitoring video data to obtain image frames; and
performing Gaussian filtering, image denoising, and image enhancement processing on the image frames to obtain the examination frame data.

As a preferred solution, the selecting key frames from the examination frame data, performing face recognition on the key frames in sequence, comparing recognized faces with a preset examinee information database for analysis, and labeling examinee information obtained through analysis in the key frames are specifically as follows:
performing the face recognition on all the examination frame data using a face recognition model, selecting the key frames from the examination frame data where faces are not occluded accordingly, and obtaining face information after the face recognition of the key frames, where all faces can be recognized in each of the key frames; and
the recognized face information is compared with the preset examinee information database, and the examinee information is labeled to the recognized face information in each of the key frames.

As a preferred solution, the capturing skeletal topology information of labeled faces, constructing skeletal topology for each examinee, and continuously monitoring the skeletal topology and the examination monitoring video data based on a preset suspicious behavior recognition model are specifically as follows:
capturing skeletal topology information of the faces with the examinee information labeled on all the key frames, and constructing the skeletal topology for each examinee in sequence;
performing behavior posture recognition on the skeletal topology for each examinee according to the preset behavior recognition model to obtain behavior information of each examinee in each of the key frames;
predicting and supplementing skeletal posture and behavior information of each examinee at a corresponding moment on a non-key frame according to the behavior information of each examinee in each of the key frames, so as to obtain complete behavior information of each examinee in the examination monitoring video data; and
monitoring and recognizing the complete behavior information of each examinee in the examination monitoring video data using the preset suspicious behavior recognition model to obtain skeletal topology with suspicious behavior, where the suspicious behavior includes all actions unrelated to writing, reading, and head-up actions.

As a preferred solution, the predicting and supplementing skeletal posture and behavior information of each examinee at a corresponding moment on a non-key frame according to the behavior information of each examinee in each of the key frames, so as to obtain complete behavior information of each examinee in the examination monitoring video data are specifically as follows:
predicting and supplementing the complete behavior information of each examinee in sequence, such that examination frame images are extracted according to the preset behavior recognition model in the process, complete skeletal topology and behavior information of the examinee in the examination video data can be recognized through the examination frame images, skeletal posture and behavior in sequence are predicted according to the behavior predict model for a frame moment corresponding to the examination frame data from which the skeletal topology and behavior information of the examinee cannot be recognized in combination with the behavior information of each key frame of the examinee, skeletal posture and behavior information predicted therefrom are then inputted in sequence into the examination frame data at the frame moment until the examination frame data of all frame moments have the skeletal posture and behavior information of the examinee, such that the complete behavior information of the examinee is acquired; and
until complete behavior information of all examinees in the examination monitoring video data is acquired.

As a preferred solution, the step of when the actual spacing distance is less than a preset value, the skeletal topologies of the two suspicious postures corresponding to the actual spacing distance are taken as abnormal behavior skeletons, and the examinee information labeled in the abnormal behavior skeletons are outputted to complete the analysis of collective abnormal behavior are specifically as follows:
when the actual spacing distance is less than the preset value, the skeletal topologies of the two suspicious postures corresponding to the actual spacing distance are taken as abnormal behavior analysis skeletons;
behavior recognition is performed on the abnormal behavior analysis skeletons in sequence; when suspicious behavior is recognized in one of the abnormal behavior analysis skeletons, behavior information of all accomplice skeletons with a preset distance of the abnormal behavior analysis skeleton is obtained, such that whenever the abnormal behavior analysis skeleton performs the suspicious behavior, a number of times that the abnormal behavior analysis skeletons and the accomplice skeletons thereof cyclically perform a same action is recorded when any of the accomplice skeletons is recognized performing head-up action and/or writing action; and
when the number of times exceeds a preset number of times, the abnormal behavior analysis skeleton and the accomplice skeletons are taken as the abnormal behavior skeletons, and the examinee information labeled in the abnormal behavior skeletons is outputted.

As a preferred solution, the above step further includes:
when the actual spacing distance is great than or equal to the preset value, behavior recognition is performed on the skeletal topologies of suspicious postures is recognized;
whenever suspicious behavior is recognized in one of the skeletal topologies of suspicious postures, behavior information of all accomplice skeletons with a preset distance of the skeletal topology is obtained, such that whenever the one of the skeletal topologies of suspicious postures perform the suspicious behavior, a number of times that the one of the skeletal topologies of suspicious postures and the accomplice skeletons thereof cyclically perform a same action is recorded when any of the accomplice skeletons is recognized performing head-up action and/or writing action; and
when the number of times exceeds the preset number of times, the one of the skeletal topologies of suspicious postures and the accomplice skeletons thereof are taken as the abnormal behavior skeletons, and the examinee information labeled in the abnormal behavior skeletons is outputted.

It will be apparent to those skilled in the art that, for the convenience and simplicity of description, specific working process of the above device can be referred to the corresponding process in the embodiments, which will not be described in detail herein.

The above embodiment has the following effects:

The technical solution of the present disclosure acquires the examination monitoring video data from the examination room. After performing frame division and preprocessing, key frames are selected, and the examinee information corresponding to the recognized face in sequence is labeled, skeletal topology information of the labeled face is captured to construct skeletal topology for each examinee, the skeletal topology and the examination monitoring video data are continuously monitored according to a preset suspicious behavior recognition model; the skeletal topologies of the two suspicious postures corresponding to the actual spacing distance are accurately and quickly determined in combination with the an actual spacing distance between skeletal topologies of each of the suspicious postures, such that the information of corresponding examinees involved in the collective abnormal behavior is quickly outputted; and the analysis of skeletal behavior can avoid blind spots of machine vision recognition, and address inaccuracies in machine vision behavior detection, thereby improving the accuracy of collective abnormal behavior detection by combining the detection of actual spacing distance.

### Embodiment

Accordingly, the present disclosure further provides a terminal device, including a processor, a memory, and a computer program stored in the memory and configured to be executed by the processor. When the processor executes the computer program, the collective abnormal behavior analysis method based on dynamic topology as described in any of the embodiments above can be implemented.

The terminal device in this embodiment includes: a processor, a memory, and a computer program or a computer instruction stored in the memory and executable on the processor. When the processor executes the computer program to implement the steps of the first embodiment described above, for example, the steps S101 to S105 as shown in FIG. 1. Alternatively, when the processor executes the computer program to implement the functions of each module/unit in the above embodiment for the device, such as the analysis module 205.

Illustratively, the computer program may be divided into one or more modules/units, the one or more modules/units can be sorted in the memory and executed by the processor to implement the present disclosure. The one or more modules/units can be a series of computer program instruction segments capable of performing a specific function, and the instruction segments are used to describe the execution process of the computer program on the terminal device. For example, the analysis module 205 is configured for outputting the examinee information labeled in the abnormal behavior skeletons to complete the analysis of collective abnormal behavior when the actual spacing distance is less than a preset value, the skeletal topologies of the two suspicious postures corresponding to the actual spacing distance are taken as abnormal behavior skeletons.

The terminal device can be a desktop computer, laptop, handheld computer, cloud server, or other computing devices. The terminal device can include, but is not limited to, a processor and a memory. Those skilled in the art will understand that the schematic diagram is merely an example of a terminal device and does not limit the terminal device, which can include more or fewer components than those illustrated, or combination of certain components, or different components. For example, the terminal device can also include input/output devices, network access devices, buses, and the like.

The processor can be a central processing unit (CPU), or other general-purpose processor, digital signal processor (DSP), application-specific integrated circuit (ASIC), field-programmable gate array (FPGA), or other programmable logic device, discrete gate or transistor logic device, discrete hardware component, and the like. The general-purpose processor can be a microprocessor, or any conventional processor, and the processor is a control center of the terminal device, connecting various parts of the terminal device through various interfaces and lines.

The memory can be used to store the computer program and/or modules, and the process implements various functions of the terminal device by running or executing the computer program and/or modules stored in the memory, and by calling the data stored in the memory. The memory primarily can primarily include a program storage area and a data storage area, where the program storage area can store an operating system, and at least one application program required for at least one function, and the like, and the data storage area can store the data created during the use of the mobile terminal, and the like. In addition, the memory can include a high-speed random access memory, and can also include a non-volatile memory, such as hard disk, memory, plug-in hard disk, smart media card (SMC), secure digital (SD) card, flash card, at least one disk storage device, flash memory devices, or other volatile solid-state storage device.

When the modules/units integrated in the terminal device are implemented as software functional units and sold or used as independent products, they may be stored in a computer-readable storage medium. Those skilled in the art may understand that implementation of all or some procedures in the methods of the above examples may be accomplished by instructing related hardware by means of a computer program. The computer program can be stored in the computer-readable storage medium, and when the computer program is executed, the procedures of the above embodiment for the method can be included. The computer program includes computer program code, the computer program code can be in the form of source code, object code, executable file or some intermediate form. The computer-readable medium can include: any entity or device capable of carrying the computer program code, recording medium, USB drive, mobile hard drive, magnetic disk, optical disk, computer memory, read-only memory (ROM), random access memory (RAM), electrical wave signal, telecommunication signal, and software distribution medium, and the like. It should be noted that the contents included in the computer-readable medium can be properly added or deleted according to the requirements of the legislation and patent practices in the jurisdiction, for example, the computer-readable medium does not include electrical wave signals and telecommunication signals in some jurisdictions according to the legislation and patent practice therein.

### Embodiment

Accordingly, the present disclosure further provides a computer-readable storage medium, where the computer-readable storage medium includes a stored computer program, and when the computer program runs, the device on which the computer-readable storage medium is located is controlled to execute the collective abnormal behavior analysis method based on dynamic topology as described in any of the embodiments above.

The objective, the technical solution and the beneficial effects of the present disclosure are further explained in detail by means of the specific embodiments described above, and it should be understood that the above mentioned are only specific embodiments of the present disclosure and are not intended to limit the scope of protection of the present disclosure. It should be particularly noted that for those of ordinarily skilled in the art, any modifications, equivalent substitutions, improvements, and the like within the spirit and principles of the present disclosure are intended to be included within the scope of protection of the present disclosure.

What is claimed is:

1. A collective abnormal behavior analysis method based on dynamic topology, comprising:
acquiring examination monitoring video data of an examination room, and performing frame division and preprocessing on the video data to obtain examination frame data, wherein the video data after frame division comprises a plurality of the examination frame data;
selecting key frames from the examination frame data, performing face recognition on the key frames in sequence, comparing recognized faces with a preset examinee information database for analysis, and labeling examinee information obtained through analysis in the key frames;
capturing skeletal topology information of labeled faces, constructing skeletal topology for each examinee, and continuously monitoring the skeletal topology and the examination monitoring video data according to a preset suspicious behavior recognition model; capturing skeletal topology information of the faces with the examinee information labeled on all the key frames, and constructing the skeletal topology for each examinee in sequence; performing behavior posture recognition on the skeletal topology for each examinee according to the preset behavior recognition model to obtain behavior information of each examinee in each of the key frames; predicting and supplementing skeletal posture and behavior information of each examinee at a corresponding moment on a non-key frame according to the behavior information of each examinee in each of the key frames, so as to obtain complete behavior information of each examinee in the examination monitoring video data; and monitoring and recognizing the complete behavior information of each examinee in the examination monitoring video data using the preset suspicious behavior recognition model to obtain skeletal topology with suspicious behavior, wherein the suspicious behavior comprises all actions unrelated to writing, reading, and head-up actions;
recording suspicious postures of each skeletal topology in sequence, and obtaining an actual spacing distance between skeletal topologies of each of the suspicious postures based on coordinate information of the skeletal topology with suspicious posture in the examination monitoring video data; and
when the actual spacing distance is less than a preset value, skeletal topologies of two suspicious postures corresponding to the actual spacing distance are taken as abnormal behavior skeletons, and the examinee information labeled in the abnormal behavior skeletons are outputted to complete the analysis of collective abnormal behavior; when the actual spacing distance is less than the preset value, the skeletal topologies of the two suspicious postures corresponding to the actual spacing distance are taken as abnormal behavior analysis skeletons; behavior recognition is performed on the abnormal behavior analysis skeletons in sequence; when suspicious behavior is recognized in one of the abnormal behavior analysis skeletons, behavior information of all accomplice skeletons with a preset distance of the abnormal behavior analysis skeleton is obtained, such that whenever the abnormal behavior analysis skeleton performs the suspicious behavior, a number of times that the abnormal behavior analysis skeletons and the accomplice skeletons thereof cyclically perform a same action is recorded when any of the accomplice skeletons is recognized performing head-up action and/or writing action; and when the number of times exceeds a preset number of times, the abnormal behavior analysis skeleton and the accomplice skeletons are taken as the abnormal behavior skeletons, and the examinee information labeled in the abnormal behavior skeletons is outputted.

2. The collective abnormal behavior analysis method based on dynamic topology according to claim 1, wherein the acquiring examination monitoring video data of an examination room, and performing frame division and preprocessing on the video data are specifically as follows:
acquiring the examination monitoring video data of the examination room via a camera;
performing frame division of the examination monitoring video data to obtain image frames; and
performing Gaussian filtering, image denoising, and image enhancement processing on the image frames to obtain the examination frame data.

3. The collective abnormal behavior analysis method based on dynamic topology according to claim 2, wherein the selecting key frames from the examination frame data, performing face recognition on the key frames in sequence, comparing recognized faces with a preset examinee information database for analysis, and labeling examinee information obtained through analysis in the key frames are specifically as follows:
performing the face recognition on all the examination frame data using a face recognition model, selecting the key frames from the examination frame data where faces are not occluded accordingly, and obtaining face information after the face recognition of the key frames, wherein all faces can be recognized in each of the key frames; and
comparing the recognized face information with the preset examinee information database for analysis, and labeling the examinee information to the recognized face information in each of the key frames.

4. The collective abnormal behavior analysis method based on dynamic topology according to claim 3, wherein the predicting and supplementing skeletal posture and behavior information of each examinee at a corresponding moment on a non-key frame according to the behavior information of each examinee in each of the key frames, so as to obtain complete behavior information of each examinee in the examination monitoring video data are specifically as follows:
predicting and supplementing the complete behavior information of each examinee in sequence, such that examination frame images are extracted according to the preset behavior recognition model in the process, complete skeletal topology and behavior information of the examinee in the examination video data can be recognized through the examination frame images, skeletal posture and behavior in sequence are predicted according to the behavior predict model for a frame moment corresponding to the examination frame data from which the skeletal topology and behavior information of the examinee cannot be recognized in combination with the behavior information of each key frame of the examinee, skeletal posture and behavior information predicted therefrom are then inputted in sequence into the examination frame data at the frame moment until the examination frame data of all frame moments have the skeletal posture and behavior information of the examinee, such that the complete behavior information of the examinee is acquired; and
until complete behavior information of all examinees in the examination monitoring video data is acquired.

5. The collective abnormal behavior analysis method based on dynamic topology according to claim 1, further comprising:
when the actual spacing distance is great than or equal to the preset value, behavior recognition is performed on the skeletal topologies of suspicious postures is recognized;
whenever suspicious behavior is recognized in one of the skeletal topologies of suspicious postures, behavior information of all accomplice skeletons with a preset distance of the skeletal topology is obtained, such that whenever the one of the skeletal topologies of suspicious postures perform the suspicious behavior, a number of times that the one of the skeletal topologies of suspicious postures and the accomplice skeletons thereof cyclically perform a same action is recorded when any of the accomplice skeletons is recognized performing head-up action and/or writing action; and
when the number of times exceeds the preset number of times, the one of the skeletal topologies of suspicious postures and the accomplice skeletons thereof are taken as the abnormal behavior skeletons, and the examinee information labeled in the abnormal behavior skeletons is outputted.

6. A collective abnormal behavior analysis device based on dynamic topology, comprising an acquisition module, a recognition module, a skeleton module, a distance module and an analysis module;
the acquisition module is configured for acquiring examination monitoring video data of an examination room, and performing frame division and preprocessing on the video data to obtain examination frame data, wherein the video data after frame division comprises a plurality of examination frame data;
the recognition module is configured for selecting key frames from the examination frame data, performing face recognition on the key frames in sequence, comparing recognized faces with a preset examinee information database for analysis, and labeling examinee information obtained through analysis in the key frames;
the skeleton module is configured for capturing skeletal topology information of labeled faces, constructing skeletal topology for each examinee, and continuously monitoring the skeletal topology and the examination monitoring video data according to a preset suspicious behavior recognition model; capturing skeletal topology information of the faces with the examinee information labeled on all the key frames, and constructing the skeletal topology for each examinee in sequence; performing behavior posture recognition on the skeletal topology for each examinee according to the preset behavior recognition model to obtain behavior information of each examinee in each of the key frames; predicting and supplementing skeletal posture and behavior information of each examinee at a corresponding moment on a non-key frame according to the behavior information of each examinee in each of the key frames, so as to obtain complete behavior information of each examinee in the examination video data; and monitoring and recognizing the complete behavior information of each examinee in the examination video data using the preset suspicious behavior recognition model to obtain skeletal topology with suspicious behavior, wherein the suspicious behavior comprises all actions unrelated to writing, reading, and head-up actions;
the distance module is configured for recording suspicious postures of each skeletal topology in sequence, and obtaining an actual spacing distance between skeletal topologies of each of the suspicious postures based on coordinate information of the skeletal topology with suspicious posture in the examination monitoring video data; and
the analysis module is configured for taking the skeletal topologies of the two suspicious postures corresponding to the actual spacing distance as abnormal behavior skeletons when the actual spacing distance is less than a preset value, and the examinee information labeled in the abnormal behavior skeletons are outputted to complete the analysis of collective abnormal behavior; when the actual spacing distance is less than the preset value, the skeletal topologies of the two suspicious postures corresponding to the actual spacing distance are taken as abnormal behavior analysis skeletons; behavior recognition is performed on the abnormal behavior analysis skeletons in sequence; when suspicious behavior is recognized in one of the abnormal behavior analysis skeletons, behavior information of all accomplice skeletons with a preset distance of the abnormal behavior analysis skeleton is obtained, such that whenever the abnormal behavior analysis skeleton performs the suspicious behavior, a number of times that the abnormal behavior analysis skeletons and the accomplice skeletons thereof cyclically perform a same action is recorded when any of the accomplice skeletons is recognized performing head-up action and/or writing action; and when the number of times exceeds a preset number of times, the abnormal behavior analysis skeleton and the accomplice skeletons are taken as the abnormal behavior skeletons, and the examinee information labeled in the abnormal behavior skeletons is outputted.

7. A terminal device, comprising a processor, a memory, and a computer program stored in the memory and configured to be executed by the processor; when the processor executes the computer program, the collective abnormal behavior analysis method based on dynamic topology according to claim 1 can be implemented.

8. A computer-readable storage medium, comprising a stored computer program, and when the computer program runs, the device on which the computer-readable storage medium is located is controlled to execute the collective abnormal behavior analysis method based on dynamic topology according to claim 1 can be implemented.
